(19) United States
(12) Patent Application Publication
(10) Pub. No.: US 2006/0117170 A1
(43) Pub. Date: Jun. 1, 2006

(54) Controller having auto-run function

(76) Inventor: Wesley Cheng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/042,121

(22) Filed: Jan. 26, 2005

(30) Foreign Application Priority Data
Oct. 14, 2004 (TW) 93131194

(51) Int. Cl. G06F 9/00

(52) U.S. Cl. 713/2

(57) ABSTRACT

A controller for reading and executing a file stored in a non-volatile memory is described. The controller includes a computer interface converter and a control module. The module is used to read the file from the non-volatile memory. The control module simulates the protocol of an optical disk and provides an auto-run identification signal to the operation system of the computer through the computer interface converter. After obtaining the auto-run identification signal, the operation system reads the file via the computer interface converter and automatically executes the file. When no auto-run identification signal is provided, the control module communicates with the operation system by the protocol of a general removable storage unit.

### RELATED APPLICATIONS

The present application is based on, and claims priority from, Taiwan Application Serial Number 93131194, filed Oct. 14, 2004, the disclosure of which is hereby incorporated by reference herein in its entirety.

### BACKGROUND

1. Field of Invention

The present invention relates to a controller and a memory card. More particularly, the present invention relates to a controller and a memory card that can automatically execute files stored in the memory card.

2. Description of Related Art

The applications of electronic products become broadened as human activities increase. With the advance of non-volatile memory, one can carry large sized files by a portable and small volume mass storage product. For example, a salesman can carry a video introduction of products in his pocket; a game company can provide a demonstration of a game in non-volatile memory; and a software company can provide a trial version of its application program in the memory. A non-volatile memory is more convenient from the aspect of reading and writing ability; yet the physical size of a non-volatile memory is smaller than that of an optical disk. Therefore, it is a popular storage medium.

Conventionally, when a memory card is connected to a card reader and the card reader is connected to a computer having an operating system (such as Microsoft Windows), the operating system deals with the card reader and the memory card as a removable storage unit. The user has to manually select a file stored in the removable storage unit and double-click it with an input device to execute the file. On many occasions, this manual method is not convenient. For example, executing a file for giving a brief to an audience, demonstrating a game, or installing an application is not convenient if one has to manually select and execute the file. If a computer can automatically execute the file without manually viewing, selecting and clicking the file by a user, the problem of no corresponding program being installed in the computer can be overcome. This is very convenient for a user who is not familiar with the executing process.

If a file for briefing, a demonstration program of a game, or an application program is stored in an optical disk, an operating system (such as Microsoft Windows) is capable of automatically executing and displaying the specific program. Conventionally, an ‘Autorun.inf’ file is stored in the optical disk and the operating system follows the commands of the Autorun.inf file to automatically execute designated files. However, operating systems on the market do not support the auto-run function of widely used removable storage units.

Therefore, a new controller and memory card that allow automatic execution without any manual process is in great need.

### SUMMARY

It is therefore an objective of the present invention to provide a controller that can automatically execute files in a compatible memory card.

It is another objective of the present invention to provide a memory card, where the files in the memory card can be automatically executed by a compatible card reader control module.

It is still another objective of the present invention to provide a mobile disk, where when a memory disk is inserted into one end of the mobile disk, the mobile disk can be used as a card reader, and when a computer is connected to another end of the mobile disk, the computer can use the mobile disk as an ordinary removable storage unit.

It is still another objective of the present invention to provide a mobile disk, where the mobile disk is portable and is convenient for a user to automatically execute the files in the memory card. The files can be a program for giving a briefing to an audience, a demonstration of a game, or an application program.

In accordance with the foregoing and other objectives of the present invention, a controller is described. The controller can read and automatically execute a file stored in a non-volatile memory. According to an embodiment of the invention, the controller includes a computer interface converter and a control module.

The computer interface converter is connected to a computer. An operating system is installed in the computer. The control module reads a file stored in a non-volatile memory. The control module simulates a communication protocol of an optical disk and provides an auto-run identification signal to the operating system. After receiving the auto-run identification signal, the operating system reads the file through the computer interface converter and automatically executes the file. When the control module doesn't provide the auto-run identification signal, the control module communicates with the operating system using a communication protocol of a removable storage unit.

The computer interface converter is, for example, a USB (universal serial bus) interface. The USB interface communicates with the operating system using a USB communication protocol. The computer interface converter can also be a PCMCIA, an RS 232, a printer port, an IEEE 1394, an IrDA, or a wireless communication module. The memory card is, for example, an MS Card, a CF Card, an SD Card, or an MMC.

The non-volatile memory can be divided into a plurality of partitions in advance. Each partition stores at least one file. At least one of the partitions provides an auto-run identification signal. The operating system uses the auto-run identification signal to determine whether to automatically execute the file in the corresponding partition.

According to one embodiment of the invention, a memory card having an auto-run function is described. The memory card includes a non-volatile memory and a memory controller.

The non-volatile memory stores a file. The memory controller controls the non-volatile memory. The memory controller is connected to a computer through a card reader control module and a computer interface converter. An operating system is installed in the computer. The memory card provides an auto-run identification signal. The operating system obtains the auto-run identification signal through the computer interface converter and the card reader control module. The operating system reads the file through the memory controller and executes the file.

A predetermined communication protocol is provided between the memory controller and the card reader control module. A simulated communication protocol of an optical disk is provided between the computer interface converter and the operating system.

According to one embodiment of the invention, a mobile disk is described. The mobile disk has a function of a card reader. The mobile disk includes a non-volatile memory, a computer interface converter, and a card reader control module.

The non-volatile memory stores a first file. The computer interface converter connects to a computer. An operating system is installed in the computer. The card reader control module connects to a memory card. The memory card stores a second file.

When the first file provides a first auto-run identification signal, the operating system obtains the first auto-run identification signal through the computer interface converter and automatically executes the first file. When the second file provides a second auto-run identification signal, the operating system obtains the second auto-run identification signal through the computer interface converter and the card reader control module and automatically executes the second file. A simulated communication protocol of an optical disk is provided between the computer interface converter and the operating system.

The invention has at least the following advantages and each embodiment can present one or more of the advantages. The controller of this invention can automatically execute files in a compatible memory card. The files in the memory card can be automatically executed by a compatible card reader control module. When a memory disk is inserted into one end of the mobile disk, the mobile disk can be used as a card reader. When a computer is connected to another end of the mobile disk, the computer can use the mobile disk as an ordinary removable storage unit. The mobile disk is portable and is convenient for a user to automatically execute the files in the memory card. The file can be a program for giving a briefing to an audience, a demonstration of a game, or an application program.

It is to be understood that both the foregoing general description and the following detailed description are examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a block diagram illustrating an embodiment of the invention;

FIG. 2 is a diagram illustrating exemplary partition types according to the invention;

FIG. 3 shows an exemplary command sequence; and

FIG. 4 illustrates another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

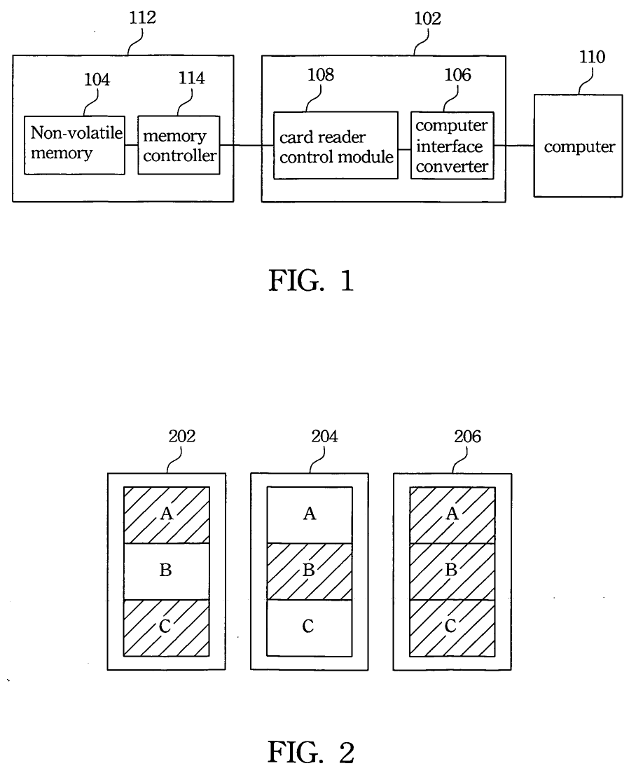

FIG. 1 is a block diagram illustrating an embodiment of the invention. With reference to FIG. 1, controller 102 is used to read a file stored in a non-volatile memory 104 and automatically execute the file. The controller 102 includes a computer interface converter 106 and a control module 108. The computer interface converter 106 is connected to a computer 110. An operating system is installed in the computer 110.

The control module 108 reads the file stored in the non-volatile memory 104. The control module 108 simulates a communication protocol of an optical disk. The control module 108 provides an auto-run identification signal to the operating system through the computer interface converter 106. After obtaining the auto-run identification signal, the operating system reads the file through the computer interface converter 106 and automatically executes the file. When the control module 108 does not provide theauto-run-identification-signal, the-control module 108 communicates with the operating system using a communication protocol of a removable storage unit.

A removable storage unit is a storage device that can be removed from a computer. The communication protocol of a removable storage unit is, for example, a USB Mass Storage communication protocol defined by Microsoft.

In one embodiment, the computer interface converter 106 is a USB (universal serial bus) interface. The USB interface communicates with the operating system using a USB communication protocol. In another embodiment, the computer interface converter 106 is, for example, a PCMCIA, an RS 232, a printer port, an IEEE 1394, an IrDA, or a wireless communication module.

In one embodiment, the non-volatile memory 104 is, for example, a hard disk or a Micro HD. In another embodiment, the non-volatile memory 104 is located in a memory card 112. The memory card 112 has a memory controller 114. The control module 108 reads the file through the memory controller 114. A suitable memory card is, for example, an MS Card, a CF Card, an SD Card, or an MMC.

The controller 102 is also called a card reader on the market. The controller 102 can be separated from the computer 110 and is portable. The controller 102 can be re-connected to the computer 110 if needed. The memory card 112 can also be separated from the controller 102 and is portable, too. Also, the memory card 112 can be re-connected to the controller 102 if needed.

In one embodiment, the auto-run identification signal is stored in the non-volatile memory 104 in a file format. The operating system obtains the auto-run identification signal through the control module 108 and automatically executes the file.

Conventionally, when a memory card is connected to a card reader and the card reader is connected to a computer having an operating system (such as Microsoft Windows), the operating system deals with the card reader and the memory card as a removable storage unit. The user has to manually select a file stored in the removable storage unit and double-click it with an input device to execute the file. On many occasions, this manual method is not convenient. For example, executing a file for giving a briefing to an audience, demonstrating a game, or installing an application is not convenient if one has to manually select and execute the selected file. If a computer can automatically execute the file without manually viewing, selecting and clicking the file by a user, it will be very convenient.

If a file for briefing, a demonstration program of a game, or an application program is stored in an optical disk, an operating system (such as Microsoft Windows) is capable of automatically executing and displaying the specific program. Conventionally, an ‘Autorun.inf’ file is stored in the optical disk and the operating system follows the commands of the Autorun.inf file to automatically execute designated files. However, no operating system supports the auto-run function of widely used removable storage units.

In this invention, the controller 102 reads the file from the memory card 112 and uses a predetermined communication protocol to determine whether to execute the file stored in the memory card 112. A file can be stored in the memory card 112 to serve as an auto-run identification signal. When the operating system obtains the auto-run identification signal through the computer interface converter 106 and the control module 108, the operating system can automatically execute the file according to the commands of the auto-run identification signal.

The communication between the memory controller 114 and the control module 108 is accomplished by a predetermined communication protocol. In other words, the protocol between the memory controller 114 and the control module 108 can be determined by the user, as long as the control module 108 can get the auto-run identification signal.

For example, many memory controllers known on the market provide command sets for card readers. There are extra commands that are not used in normal situations and can be used to transmit the auto-run identification signal. Users can define commands by themselves to establish a protocol between the memory controller 114 and the control module 108.

The communication protocol between the control module 108 and the computer interface converter 106 simulates a communication protocol of an optical disk. Because most operating systems on the market support the auto-run function of an optical disk, the control module 108 simulates an optical disk's communication protocol. The control module 108 communicates with the operating system with the simulated communication protocol. At this time, the operating system sees the memory card 112 as an optical disk and then performs the auto-run process.

In other words, although the memory card 112 is not a real optical disk, the computer 110 can automatically execute the file stored in the memory card 112 according to a conventional method used to automatically execute a file stored in an optical disk.

FIG. 2 is a diagram illustrating exemplary partition types according to the invention. With reference to FIG. 1 and FIG. 2, in one embodiment, the non-volatile memory 104 is divided into a plurality of partitions in advance. Each partition stores at least one file. At least one of the partitions provides an auto-run identification signal, and the operating system uses the auto-run identification signal to determine whether to automatically execute the file in the corresponding partition.

For example, in FIG. 2, the memory card 202 is divided into three partitions, i.e., partitions A, B, and C. The shadowed portion represents a partition that has been designated to auto-run. Thus, with the controller 102 mentioned above (shown in FIG. 1), when the memory card 202 is inserted into the controller 102, the computer 110 sees the partitions A and C, through the card reader control module 108 and the memory controller 114, as two optical disks that can be automatically executed. The computer 110 then automatically executes files stored in partitions A and C.

Similarly, in the memory card 204, partition B is designated to automatically execute. So, when the memory card 204 is inserted into the controller 102, the computer 110 sees the partition B, through the card reader control module 108 and the memory controller 114, as an optical disk that can be automatically executed. The computer 110 then automatically executes files stored in partition B. The partitions A, B, and C in the memory card 206 are all designated to automatically execute, so when the memory card 206 is inserted into the controller 102, all files in partitions A, B, and C can be automatically executed.

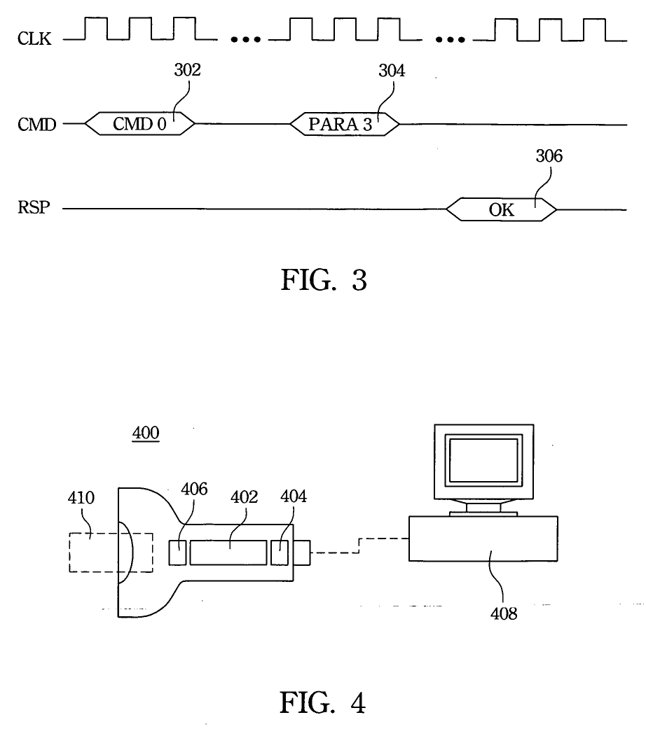

FIG. 3 shows an exemplary command sequence. Referring to FIGS. 1-3, when the memory card 112 is inserted into the controller 102, the controller 102 sends an auto-run command CMD 0 302 and another command PARA 3 304 to the memory controller 114. CMD 0 means automatic execution. PARA 3 means partition 3.

If there is no partition 3 in the memory card 112, or if no auto-run identification signal is found in partition 3, the memory controller 114 returns a FAIL command. If there is a partition 3 in the memory card 112, and the partition 3 provides an auto-run identification signal, the memory controller 114 returns an OK 306 command. The computer 110 then can automatically read and execute the files stored in the partition 3. The CLK signal in FIG. 3 represents a clock signal.

Usually, when a computer communicates with a device through a USB interface, the computer will ask which type of device the connected device is. There are three types of response to the inquiry: removable storage unit, CD-ROM, and floppy. In this invention, if both the memory controller 114 and the control module 108 support an auto-run function, the computer 110 can see the memory card 112 as a CD-ROM device and automatically execute files stored in the non-volatile memory 104. If either of the memory controller 114 or the control module 108 does not support the auto-run function, the computer 110 sees the memory card 112 as an ordinary removable storage unit.

The memory controller 114, the control module 108, and the computer interface converter 106 can be realized by a chip respectively. They can also be integrated into a chip and thus become an SOC (system-on chip).

FIG. 4 illustrates another embodiment of the invention. Referring to FIG. 4, the mobile disk 400 has a function of a card reader. The mobile disk 400 includes a non-volatile memory 402, a computer interface converter 404, and a card reader control module 406.

The non-volatile memory 402 stores a first file. The computer interface converter 404 connects to a computer 408. An operating system is installed in the computer 408. The card reader control module 406 connects to a memory card 410. The memory card 410 stores a second file.

When the first file provides a first auto-run identification signal, the operating system obtains the first auto-run identification signal through the computer interface converter 404 and automatically executes the first file. When the second file provides a second auto-run identification signal, the operating system obtains the second auto-run identification signal through the computer interface converter 404 and the card reader control module 406 and automatically executes the second file. A simulated communication protocol of an optical disk is provided between the computer interface converter 404 and the operating system.

The memory controller 114 shown in FIG. 1 has been incorporated into the card reader control module 406. The files in the non-volatile memory 402 and in the memory card 410 can be automatically executed by the computer 408.

The mobile disk 400 is portable. The memory card 410 can be separated from the mobile disk 400 and can be re-inserted into the mobile disk 400 if needed. Thus, the mobile disk 400 not only can be used as an ordinary removable storage, it also can be used as a portable card reader. It is therefore very convenient.

In this embodiment, the computer interface converter 404 is, for example, a USB interface, a PCMCIA, an RS 232, a printer port, an IEEE 1394, an IrDA, or a wireless communication module. Suitable to act as the memory card 410 is, for example, an MS Card, a CF Card, an SD Card, or an MMC. The detailed auto-run function has been described in the embodiments shown in FIGS. 1-3.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A controller for reading and automatically executing a file stored in a non-volatile memory, the controller comprising:
a computer interface converter connected to a computer, wherein an operating system is installed in the computer; and
a control module for reading a file stored in a non-volatile memory, the control module simulating a communication protocol of an optical disk and providing an auto-run identification signal to the operating system, wherein after receiving the auto-run identification signal, the operating system reads the file through the computer interface converter and automatically executes the file;
wherein when the control module doesn't provide the auto-run identification signal, the control module communicates with the operating system using a communication protocol of a removable storage unit.

2. The controller of claim 1, wherein the computer interface converter is a USB interface, and the USB interface communicates with the operating system using a USB communication protocol.

3. The controller of claim 1, wherein the computer interface converter is selected form the group consisting of a PCMCIA, an RS 232, a printer port, an IEEE 1394, an IrDA, and an wireless communication module.

4. The controller of claim 1, wherein the non-volatile memory is a hard disk.

5. The controller of claim 1, wherein the non-volatile memory is a Micro HD.

6. The controller of claim 1, wherein the non-volatile memory is located in a memory card, the memory card has a memory controller, and the control module reads the file through the memory controller.

7. The controller of claim 6, wherein the memory card is selected from the group consisting of an MS Card, a CF Card, an SD Card, and an MMC.

8. The controller of claim 1, wherein the auto-run identification signal is stored in the non-volatile memory in a file format, and the operating system obtains the auto-run identification signal through the control module and automatically executes the file.

9. The controller of claim 1, wherein the non-volatile memory is divided into a plurality of partitions in advance, each partition stores at least one file, at least one of the partitions provides an auto run identification signal, and the operating system uses the auto-run identification signal to determine whether to automatically execute the file in the corresponding partition.

10. A memory card having an auto-run function, the memory card comprising:
a non-volatile memory for storing a file; and
a memory controller for controlling the non-volatile memory, the memory controller being connected to a computer through a card reader control module and a computer interface converter, an operating system being installed in the computer, the memory card providing an auto-run identification signal, the operating system obtaining the auto-run identification signal through the computer interface converter and the card reader control module, the operating system reading the file through the memory controller and executing the file;
wherein a predetermined communication protocol is provided between the memory controller and the card reader control module, and a simulated communication protocol of an optical disk is provided between the computer interface converter and the operating system.

11. The memory card of claim 10, wherein the computer interface converter is a USB interface, and the USB interface communicates with the operating system using a USB communication protocol.

12. The memory card of claim 10, wherein the computer interface converter is selected form the group consisting of a PCMCIA, an RS 232, a printer port, an IEEE 1394 an IrDA, and a wireless communication module.

13. The memory card of claim 10, wherein the auto-run identification signal is stored in the non-volatile memory in a file format, and the operating system obtains the auto-run identification signal through the memory controller and automatically executes the file.

14. The memory card of claim 10, wherein the non-volatile memory is divided into a plurality of partitions in advance, each partition stores at least one file, each partition provides an auto-run identification signal, and the operating system uses each auto-run identification signal to determine whether to automatically execute the file in the corresponding partition.

15. The memory card of claim 10, wherein the non-volatile memory is divided into a plurality of partitions in advance, each partition stores at least one file, at least one of the partitions provides an auto-run identification signal, and the operating system uses the auto-run identification signal to determine whether to automatically execute the file in the corresponding partition.

16. A mobile disk having a function of a card reader, the mobile disk comprising:
a non-volatile memory for storing a first file;
a computer interface converter for connecting to a computer, an operating system being installed in the computer; and
a card reader control module for connecting to a memory card, the memory card storing a second file;
wherein (i) when the first file provides a first auto-run identification signal, the operating system obtains the first auto-run identification signal through the computer interface converter and automatically executes the first file, (ii) when the second file provides a second auto-run identification signal, the operating system obtains the second auto-run identification signal through the computer interface converter and the card reader control module and automatically executes the second file, and (iii) a simulated communication protocol of an optical disk is provided between the computer interface converter and the operating system.

17. The mobile disk of claim 16, wherein the computer interface converter is a USB interface, and the USB interface communicates with the operating system using a USB communication protocol.

18. The mobile disk of claim 16, wherein the computer interface converter is selected form the group consisting of a PCMCIA, an RS 232, a printer port, an IEEE 1394, an IrDA, and a wireless communication module.

19. The mobile disk of claim 16, wherein the memory card has a memory controller, and the card reader control module reads the second file through the memory controller.

20. The mobile disk of claim 19, wherein the memory card is selected from the group consisting of an MS Card, a CF Card, an SD Card, and an MMC.

21. The mobile disk of claim 16, wherein the non-volatile memory is divided into a plurality of partitions in advance, each partition stores at least one file, at least one of the partitions provides an auto-run identification signal, and the operating system uses the auto-run identification signal to determine whether to automatically execute the file in the corresponding partition.
